(19) United States
(12) Patent Application Publication
(10) Pub. No.: US 2013/0050584 A1
(43) Pub. Date: Feb. 28, 2013

(54) BACKLIGHT DEVICE AND DISPLAY APPARATUS

(71) Applicant: Takahisa Kaihotsu, Tokyo (JP)

(72) Inventor: Takahisa Kaihotsu, Tokyo (JP)

(21) Appl. No.: 13/434,222

(22) Filed: Mar. 29, 2012

(30) Foreign Application Priority Data
Aug. 31, 2011 (JP) 2011-189604

(51) Int. Cl. H04N 5/50; G09F 13/04

(52) U.S. Cl. 348/731; 362/97.1; 348/E05.097

(57) ABSTRACT

According to one embodiment, a display apparatus includes a display panel, a first light source, a first light guide module, a second light guide module, and a first illuminating module. The first light source is facing the display panel, and is configured to emit light toward a direction of the display panel. The light emitted from the first light source enters the first light guide module. The first light guide module is configured to output the light to a predetermined direction. The second light guide module is facing a first area on the display panel, and is configured to guide the light outputted from the first light guide module to illuminate the first area. The first illuminating module is configured to illuminate a second area on the display panel. The second area is different from the first area.

### CROSS REFERENCE TO RELATED APPLICATIONS

This application is based upon and claims the benefit of priority from the prior Japanese Patent Application No. 2011-189604, filed on Aug. 31, 2011, the entire contents of which are incorporated herein by reference.

### FIELD

Embodiments described herein relate generally to a backlight device and a display apparatus.

### BACKGROUND

In recent years, liquid crystal displays (LCDs) have been widely used. An LCD includes a liquid crystal panel formed by providing a liquid crystal material between two glass substrates, and a backlight device that illuminates the liquid crystal panel with light from the back face of the liquid crystal panel. Backlight devices are roughly classified into edge types and direct-illumination types.

A backlight device of an edge type illuminates the side faces of a light guide plate positioned on the back face side of a liquid crystal panel with light from light sources such as LEDs (light emitting diodes). The light is widely diffused, and is then extracted from the face of the light guide plate facing the liquid crystal panel. In this system, the backlight device can be made thinner. However, if the backlight device is made larger, it is difficult to illuminate the center of the liquid crystal panel brightly, and therefore, illuminance unevenness easily appears, or the bezel width needs to be increased to accommodate the light sources. If the bezel is wide, the display area might appear small.

A backlight device of a direct-illumination type has light sources arranged in an array directly below a liquid crystal panel, and illuminates the liquid crystal panel with light via a diffuser plate or the like. Unlike a backlight device of an edge type, this system can brightly illuminate the center of the liquid crystal panel, and therefore, illuminance unevenness does not easily appear. Furthermore, the bezel width can be reduced. However, the backlight device is thicker, and a larger number of light sources need to be prepared. Therefore, the costs are higher.

### BRIEF DESCRIPTION OF THE DRAWINGS

FIG. 1 is a schematic block diagram of an image display system having an image display apparatus 110 according to one embodiment.

FIG. 2 is a schematic block diagram of the display module 200.

FIG. 3 is a perspective view of the backlight device 6 and the liquid crystal panel 1.

FIG. 4 is a front view of the backlight device 6 and the liquid crystal panel 1 of FIG. 3, seen in a direction A.

FIG. 5 is a top view specifically showing the light source module 10.

FIGS. 6A and 6B are diagrams showing ray paths in the backlight device 6.

FIGS. 7A and 7B are modifications of the backlight device of FIG. 4.

FIG. 8 is another modification of the backlight device of FIG. 4.

FIG. 9 is a cross-sectional view of the liquid crystal panel 1 and a backlight device 61 as a modification of the backlight device of FIG. 4.

FIG. 10 is a diagram showing the ray paths in the backlight device 61 of FIG. 9.

FIG. 11 is a cross-sectional view of the liquid crystal panel 1 and a backlight device 62 as another modification of the backlight device of FIG. 4.

FIG. 12 is a diagram showing the ray paths in the backlight device 62 of FIG. 11.

FIG. 13 is a cross-sectional view of the liquid crystal panel 1 and a backlight device 63 as a modification of the backlight device of FIG. 11.

FIG. 14 is a diagram showing the ray paths in the backlight device 63.

FIG. 15 is a cross-sectional view of the liquid crystal panel 1 and a backlight device 64 as a modification of the backlight device of FIG. 4.

FIG. 16 is a diagram showing the ray paths in the backlight device 64.

### DETAILED DESCRIPTION

In general, according to one embodiment, a display apparatus includes a display panel, a first light source, a first light guide module, a second light guide module, and a first illuminating module. The first light source is facing the display panel, and is configured to emit light toward a direction of the display panel. The light emitted from the first light source enters the first light guide module. The first light guide module is configured to output the light to a predetermined direction. The second light guide module is facing a first area on the display panel, and is configured to guide the light outputted from the first light guide module to illuminate the first area. The first illuminating module is configured to illuminate a second area on the display panel. The second area is different from the first area.

Embodiments will now be explained with reference to the accompanying drawings.

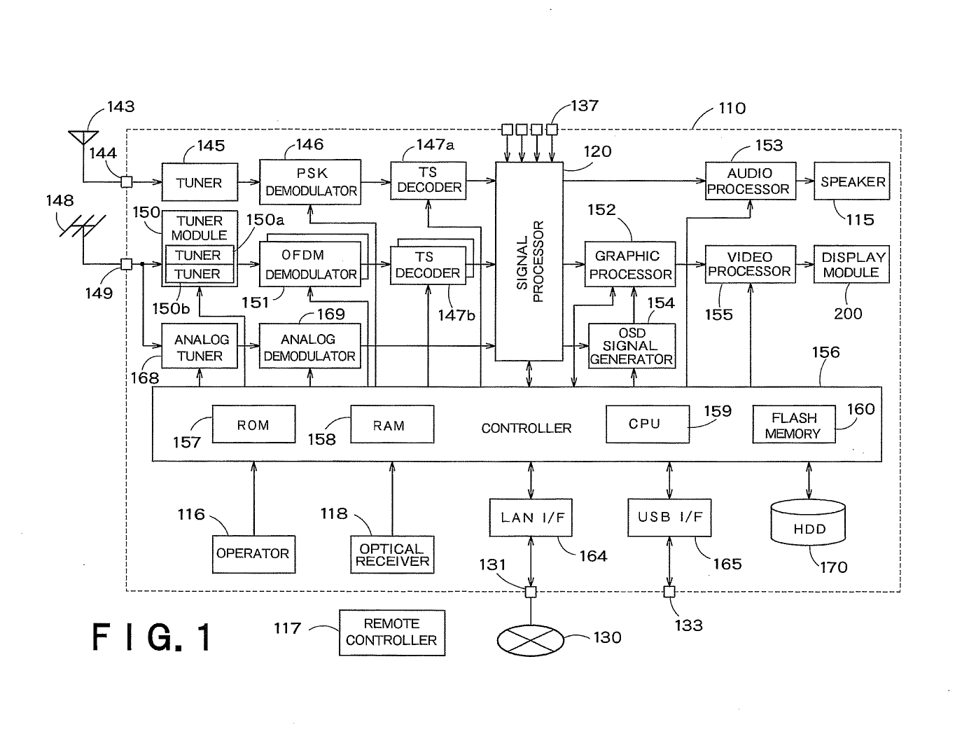

FIG. 1 is a schematic block diagram of an image display system having an image display apparatus 110 according to one embodiment.

The image display apparatus 110 has a controller 156 for controlling operations of each part, an operator 116, an optical receiver 118. The controller 156 has a ROM (Read Only Memory) 157, a RAM (Random Access Memory) 158, a CPU (Central Processing Unit) 159 and a flash memory 160.

The controller 156 activates a system control program and various processing programs stored in the ROM 157 in advance in accordance with an operation signal inputted from the operator 116 or inputted through the optical receiver 118 sent from the remote controller 117. The controller 156 controls the operations of each part according to the activated programs using the RAM 158 as a work memory of the CPU 159. Furthermore, the controller 156 stores and uses information and so on necessary for various settings in the flash memory 160 which is a non-volatile memory such as a NAND flash memory, for example.

The image display apparatus 110 further has an input terminal 144, a tuner 145, a PSK (Phase Shift Keying) demodulator 146, a TS (Transport Stream) decoder 147a and a signal processor 120.

The input terminal 144 sends a satellite digital television broadcasting signal received by an antenna 143 for receiving a BS/CS digital broadcast to the tuner 145 for the satellite digital broadcast. The tuner 145 tunes the received digital broadcasting signal to send the tuned digital broadcasting signal to the PSK demodulator 146. The PSK demodulator 146 demodulates the TS from the digital broadcasting signal to send the demodulated TS to the TS decoder 147a. The TS decoder 147a decodes the TS to a digital signal including a digital video signal, a digital audio signal and a data signal to send it to the signal processor 120.

Here, the digital video signal is a digital signal relating to a video which the image display apparatus 110 can output. The digital audio signal is a digital signal relating to an audio which the image display apparatus 110 can output. Furthermore, the data signal is a digital signal indicative of various kind of information about demodulated serves.

The image display apparatus 110 further has an input terminal 149, a tuner module having two tuners 150a and 150b, two OFDM (Orthogonal Frequency Division Multiplexing) demodulators 151, two TS decoders 147b, an analog tuner 168 and an analog demodulator 169.

The input terminal 149 sends a terrestrial digital television broadcasting signal received by an antenna 148 for receiving the terrestrial digital broadcast to the tuner 150 for the terrestrial digital broadcast. The tuners 150a and 150b in the tuner module 150 tune the received digital broadcasting signal to send the tuned digital broadcasting signal to the two OFDM demodulators 151, respectively. The OFDM demodulators 151 demodulate the TS from the digital broadcasting signal to send the demodulated TS to the corresponding TS decoder 147b. The TS decoder 147b decodes the TS to a digital video signal and a digital audio signal and so on to send them to the signal processor 120. The terrestrial digital television broadcast obtained by each of the tuners 150a and 150b in the tuner module 150 are decoded to the digital video signal, the digital audio signal and the digital signal including the data signal simultaneously by the two OFDM demodulators 151 and the TS decoders 147b, and then, can be sent to the signal processor 120.

The antenna 148 can also receive a terrestrial analog television broadcasting signal. The received terrestrial analog television broadcasting signal is divided by a divider (not shown) and sent to the analog tuner 168. The analog tuner 168 tunes the received analog broadcasting signal and sends the tuned analog broadcasting signal to the analog demodulator 169. The analog demodulator 169 demodulates the analog broadcasting signal to send the demodulated analog broadcasting signal to the signal processor 120. Furthermore, the image display apparatus 110 can display CATV (Common Antenna Television) by connecting a tuner for the CATV to the input terminal 149 connected to the antenna 148, for example.

The image display apparatus 110 further has a line input terminal 137, an audio processor 153, a speaker 115, a graphic processor 152, an OSD (On Screen Display) signal generator 154, a video processor 155 and a display 220.

The signal processor 120 performs a suitable signal processing on the digital signal sent from the TS decoders 147a and 147b or from the controller 156. More specifically, the signal processor 120 divides the digital signal into the digital video signal, the digital audio signal and the data signal. The digital video signal is sent to the graphic processor 152, and the divided digital audio signal is sent to the audio processor 153. Furthermore, the signal processor 120 converts the broadcasting signal sent from the analog demodulator 169 to a video signal and an audio signal in a predetermined digital format. The converted digital video signal is sent to the graphic processor 152, and the converted digital audio signal is sent to the audio processor 153. Furthermore, the signal processor 120 performs a digital signal processing on an input signal from the line input terminal 137.

The audio processor 153 converts the inputted audio signal to an analog audio signal in a format capable of being reproduced by the speaker 115. The analog audio signal is sent to the speaker 115 and is reproduced.

The OSD signal generator 154 generates an OSD signal for displaying an UI (User Interface) window or the like in accordance with a control of the controller 156. Furthermore, the data signal divided by the signal processor 120 from the digital broadcasting signal is converted to the OSD signal in a suitable format and is sent to the graphic processor 152.

The graphic processor 152 decodes the digital video signal sent from the signal processor 120. The decoded video signal is combined with the OSD signal sent from the OSD signal generator 154 and is sent to the video processor 155. The graphic processor 152 can send the decoded video signal or the OSD signal selectively to the video processor 155.

The video processor 155 converts the signal sent from the graphic processor 152 to an analog video signal in a format the display module 200 can display. The analog video signal is sent to the display module 200 to be displayed. The display module 200 is, for example, a crystal liquid display having a size of “12” inch or “20” inch.

The image display apparatus 110 further has a LAN (Local Area Network) terminal 131, a LAN I/F (Interface) 164, a USB (Universal Serial Bus) terminal 133, a USB I/F 165 and a HDD (Hard Disk Drive) 170.

The LAN terminal 131 is connected to the controller 156 through the LAN I/F 164. The LAN terminal 131 is used as a general LAN-corresponding port using an Ethernet (registered trademark). In the present embodiment, a LAN cable is connected to the LAN terminal 131, and it is possible to communicate with an internet 130.

The USB terminal 133 is connected to the controller 156 through the USB I/F 165. The USB terminal 133 is used as a general USB-corresponding port. For example, a cellular phone, a digital camera, a card reader/writer for various memory cards, a HDD and a key board or the like can be connected to the USB terminal 133 through a hub. The controller 156 can communicate with devices connected through the USB terminal 133.

The HDD 170 is a magnetic storage medium in the image display apparatus 110, and has a function for storing various information of the image display apparatus 110.

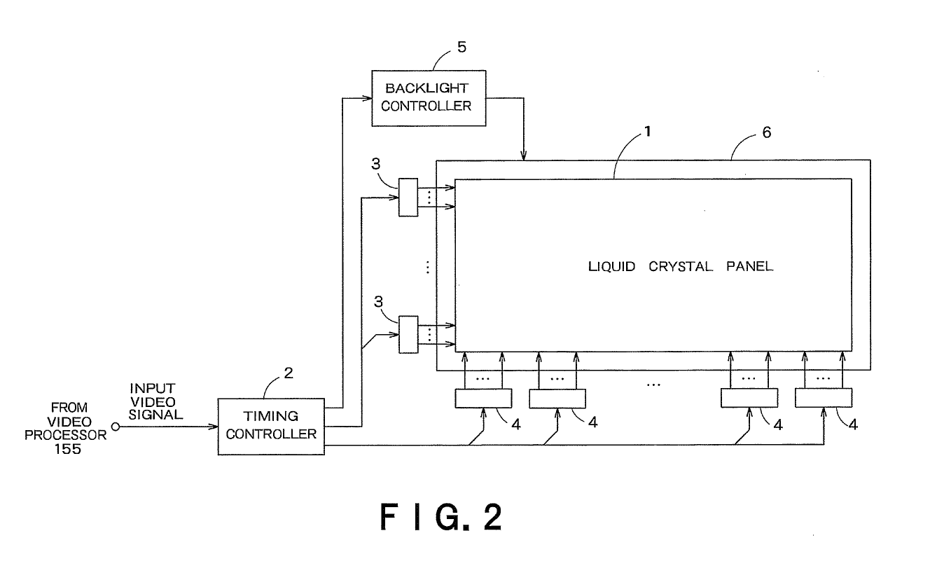

FIG. 2 is a schematic block diagram of the display module 200. The display module 200 has a liquid crystal panel (display panel) 1, a timing controller 2, a gate driver 3, a source driver 4, a backlight controller 5, and a backlight module 6.

The liquid crystal panel 1 has a structure where liquid crystal materials are put between a pair of facing glass substrates. The liquid crystal panel 1 has a plurality of (for example, “1080” of) scanning lines, a plurality of (for example, “1920*3” of) signal lines, and a plurality of liquid crystal pixels formed on each of crossing points of the scanning lines and the signal line.

The timing controller 2 provides the input video signal inputted from the video processor 155 of FIG. 1 to the source driver 4 and controls the operation timing of the gate driver 3, source driver 4 and backlight controller 5.

The gate driver 3 selects one of the scanning lines by turns. The source driver 4 provides the input video signal to the signal lines of the liquid crystal panel 1. The input video signal is provided to the liquid crystal pixel connected to the scanning line selected by the gate driver 3. According to the voltage of the supplied input video signal, alignments of the liquid crystal materials in the liquid crystal pixel vary. The gate driver 3 and the source driver 4 form a panel controller.

On the other hand, the backlight module 6 is arranged behind the liquid crystal panel 1 to irradiate light thereon. Among the irradiated light, light whose intensity depends on the alignments of the liquid crystal materials, is transmissive to the liquid crystal materials to be displayed on the liquid crystal panel 1.

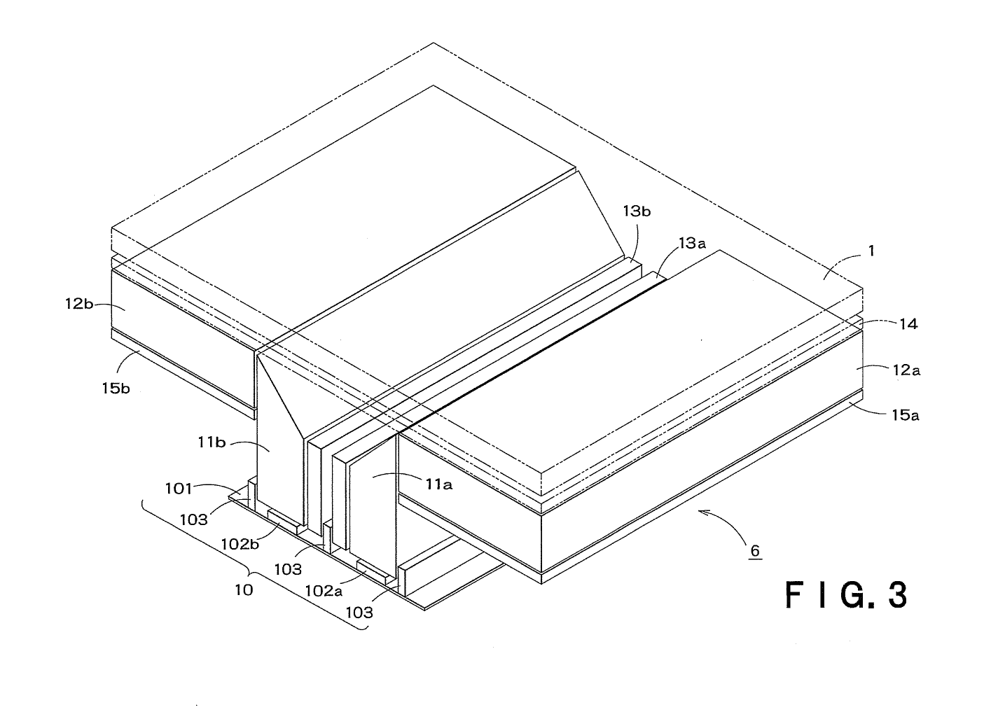

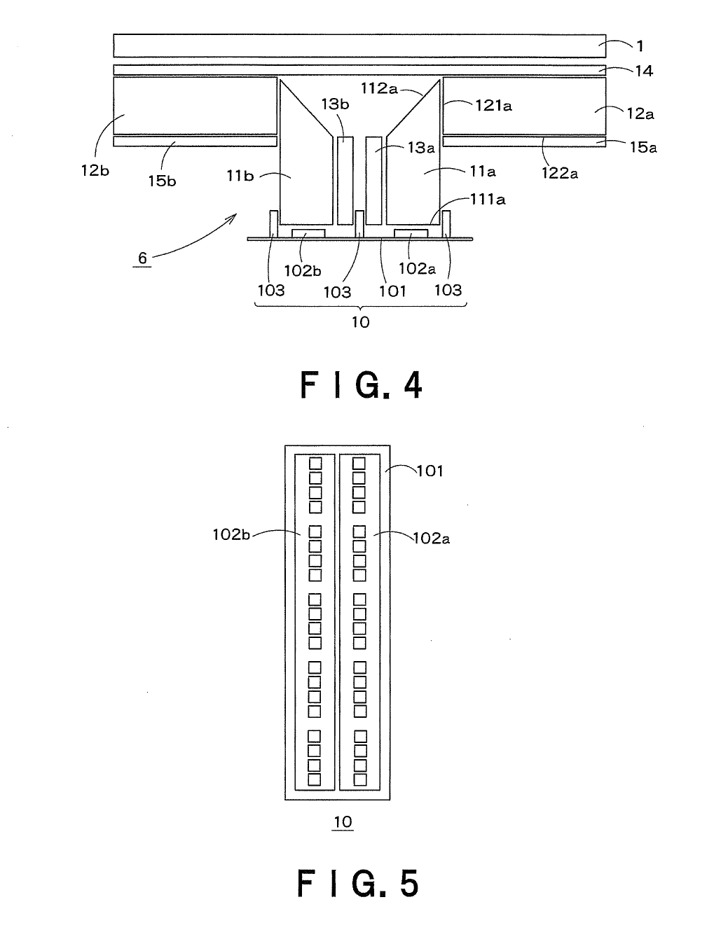

FIG. 3 is a perspective view of the backlight device 6 and the liquid crystal panel 1. FIG. 4 is a front view of the backlight device 6 and the liquid crystal panel 1 of FIG. 3, seen in a direction A. Hereinafter, the direction from the backlight device 6 toward the liquid crystal panel 1 will be referred to as the upward direction.

The backlight device 6 includes a light source module 10, main light guide paths (first light guide modules) 11a and 11b, light guide plates (second light guide modules) 12a and 12b, sub light guide paths (third light guide modules) 13a and 13b, an optical sheet 14, and chassises 15a and 15b. Since the respective members are arranged symmetrically, the components with the suffix “a” will be hereinafter mainly described.

FIG. 5 is a top view specifically showing the light source module 10. As shown in FIGS. 4 and 5, the light source module 10 includes a frame 101, two rows of LED light sources (first light sources) 102a and 102b each including LEDs, and clips 103 (not shown in FIG. 5) supporting the main light guide paths 11a and 11b and the sub light guide paths 13a and 13b. The light source module 10 is arranged facing the liquid crystal panel 1 and is located below the liquid crystal panel 1, instead of on a side of the liquid crystal panel 1. Accordingly, the bezel of the image display apparatus 110 can be made thinner. Instead of LEDs, some other light sources may be used.

The LED light sources 102a and 102b emit light perpendicularly to the liquid crystal panel 1. As shown in FIG. 4, the LED light source 102a is positioned facing the incident face 111a of the main light guide path 11a, and at least part of light emitted from the LED light source 102a, 99% of the light for example, enters the main light guide path 11a from the incident face 111a. To increase the light extraction efficiency, a reflective material may be applied to the surfaces of the frame 101 and the clips 103.

By grouping four to five LEDs among the LEDs included in the LED light source 102a and collectively controlling the luminance of each group, local dimming (which means dividing the display area into several areas, and controlling the brightness of each of the areas) can be performed.

The main light guide path 11a is made of acrylic and has a thickness of approximately 2 mm, for example. The main light guide path 11a is placed between the liquid crystal panel 1 and the LED light source 102a. The main light guide path 11a is supported by a clip 103 of the light source module 10, so as to be perpendicular to the frame 101. With thermal expansion being taken into account, it is preferable to leave a space between the LED light source 102a on the frame 101 and the incident face 111a of the main light guide path 11a.

The end face 112a of the main light guide path 11a on the side of the liquid crystal panel 1 has the shape of a triangular prism, and acts as a reflective surface tilted at 45 degrees so that the light emitted from the LED light source 102a is reflected parallel to the liquid crystal panel 1 and toward the rim, and is guided toward the light guide plate 12a. A reflective material may be applied to the end face 112a, so that the end face 112a efficiently reflects light. The length of the main light guide path 11a in the direction perpendicular to the liquid crystal panel 1 is determined so that light would be sufficiently diffused. Alternatively, the main light guide path 11a may not be provided, and a light guide module may be formed with an air layer and a reflective surface of a mirror or the like located in the position of the end face 112a.

The light guide plate 12a is a rectangular acrylic plate having a thickness of approximately 2 mm, for example. The light guide plate 12a is placed on the chassis 15a and faces the liquid crystal panel 1. The light guide plate 12a is located closer to the rim of the liquid crystal panel 1 than the main light guide path 11a is. In other words, the light guide plates 12a and 12b are arranged to sandwich the main light guide paths 11a and 11b. Light emitted from the main light guide path 11a enters the light guide plate 12a from the face 121a facing the main light guide path 11a.

A diffuser member 122a for serigraph or the like is applied to at least part of the lower face of the light guide plate 12a. Light is scattered by the diffuser member 122a, and reaches an area (a first area) on the liquid crystal panel 1 facing the light guide plate 12a. By controlling the density of the diffuser member 122a, the light illuminating the liquid crystal panel 1 can be made uniform. Meanwhile, to restrict diffusion of light to increase the straightness of the light, and to enable local dimming in each small area, slit grooves (not shown) that extend in the light traveling direction and have prism-like shapes with an apical angle of 90 degrees and a pitch of 10 μm, for example, may be formed in the upper face of the light guide plate 12a.

It is preferable to optically bond the light guide plate 12a and the main light guide path 11a to each other. This is because, if an air layer air is interposed therebetween, light may be refracted, which may change optical characteristics. When an air layer is interposed, by arranging the light guide plate 12a and the main light guide path 11a as close as possible to each other, light leakage from the space therebetween to the liquid crystal panel 1 can be restrained. Alternatively, the main light guide path 11a and the light guide plate 12a may be integrally formed to reduce the number of components.

The sub light guide path 13a is thinner than the main light guide path 11a. The sub light guide path 13a is made of acrylic and has a thickness of approximately 0.5 mm, for example. The sub light guide path 13a is located closer to the center of the liquid crystal panel 1 than the main light guide path 11a is, and is placed between the liquid crystal panel 1 and the light source module 10. The sub light guide path 13a is supported by a clip 103 of the light source module 10, so as to be perpendicular to the frame 101.

The sub light guide path 13a is not located directly above the LED light source 102a, but is obliquely positioned with respect to the LED light source 102a. At least part of light emitted from the LED light source 102a enters the sub light guide path 13a. The sub light guide path 13a is thinner than the main light guide path 11a, and is obliquely positioned with respect to the LED light source 102a. Therefore, the amount of light entering the sub light guide path 13a is smaller than the amount of light entering the main light guide path 11a, and is approximately 1% of the amount of light emitted from the LED light source 102a, for example. The amount of light entering the sub light guide path 13a may be adjusted by adjusting the distance between the sub light guide path 13a and the LED light source 102a or appropriately printing reflective dots (reflective members) on the side face of the sub light guide path 13a on the side of the LED light source 102a. In this manner, appearance of illuminance unevenness on the liquid crystal panel 1 can be restrained.

Light that enters the sub light guide path 13a exits from the face on the side of the liquid crystal panel 1, and illuminates the area of the liquid crystal panel 1 facing the sub light guide path 13a and its surrounding area (a second area). To illuminate the largest possible area on the liquid crystal panel 1, a space may be left between the liquid crystal panel 1 and the upper end face of the sub light guide path 13a.

Referring back to FIGS. 2 and 3, the optical sheet 14 is a light diffusion film, for example. The optical sheet 14 faces the liquid crystal panel 1, and is located directly below the liquid crystal panel 1. Light use efficiency can be increased by the optical sheet 14.

To maintain a fixed distance between the main light guide path 11a and the sub light guide path 13a, an optical sheet (not shown) may be interposed between these paths. Alternatively, a spacer (not shown) for maintaining a fixed clearance may be inserted between the optical source module 10 and each of the light guide plates 12a and 12b. The material of the spacer is preferably an elastic material, with thermal expansion of the light guide plates 12 being taken into account. Further, a spring may be provided between the light guide plate 12a and the chassis 15a and between the light guide plate 12b and the chassis 15b, to stabilize the structure.

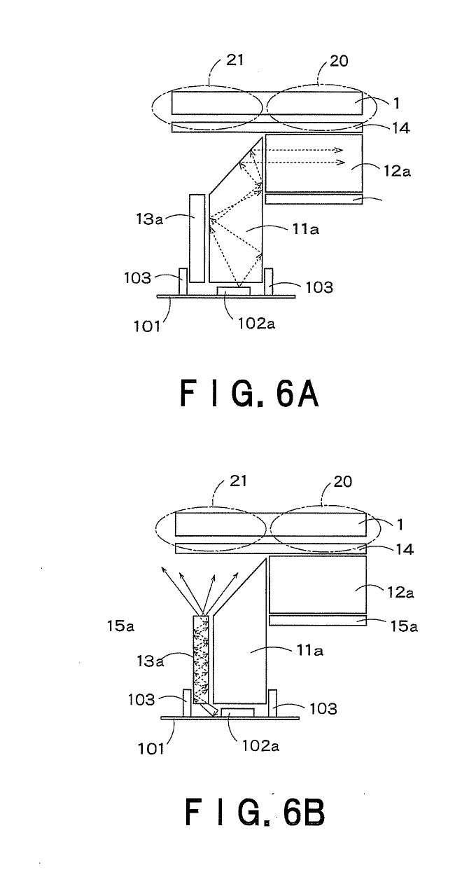

FIGS. 6A and 6B show ray paths in the backlight device 6.

FIG. 6A shows the ray paths of the light, among the light emitted from the LED light source 102a, that enters the main light guide path 11a. This light is diffused, while being totally reflected by the side faces of the main light guide path 11a. The light is not leaked to the outside, and reaches the end face 112a having the shape of a triangular prism. The light is reflected by the end face 112a, and travels in a direction almost parallel to the liquid crystal panel 1 and toward the rim. The light then enters the light guide plate 12a. As the diffuser member 122a is applied to the lower face of the light guide plate 12a, the light diffused by the diffuser member 122a exits from the upper portion of the light guide plate 12a.

In this manner, the light that enters the main light guide path 11a illuminates the area (the first area) 20 of the liquid crystal panel 1 facing the light guide plate 12a. Meanwhile, light does not pass through the end face 112a. Therefore, the light that enters the main light guide path 11a hardly illuminates the area (the second area) 21 that faces the main light guide path 11a, the area 21 being located closer to the center of the liquid crystal panel 1 than the region 20 is.

FIG. 6B shows the ray paths of the light, among the light emitted from the LED light source 102a, that enters the sub light guide path 13a. This light is diffused, while being totally reflected by the side faces of the sub light guide path 13a. The light is not leaked to the outside, and exits from the face facing the liquid crystal panel 1. The light is further diffused in the air layer, and illuminates the area that does not face the light guide plate 12a, that is, the area 21 that faces the main light guide path 11a and the sub light guide path 13a.

That is, the light that enters the main light guide path 11a can hardly illuminate the area 21 located above the main light guide path 11a, but the light that enters the sub light guide path 13a can illuminate the area 21. Also, the amount of light illuminating the area 21 can be adjusted by positioning the sub light guide path 13a obliquely with respect to the LED light source 102a and/or making the sub light guide path 13a thinner than the main light guide path 11a. In this manner, appearance of illuminance unevenness on the liquid crystal panel 1 can be restrained.

The following is a description of several modifications.

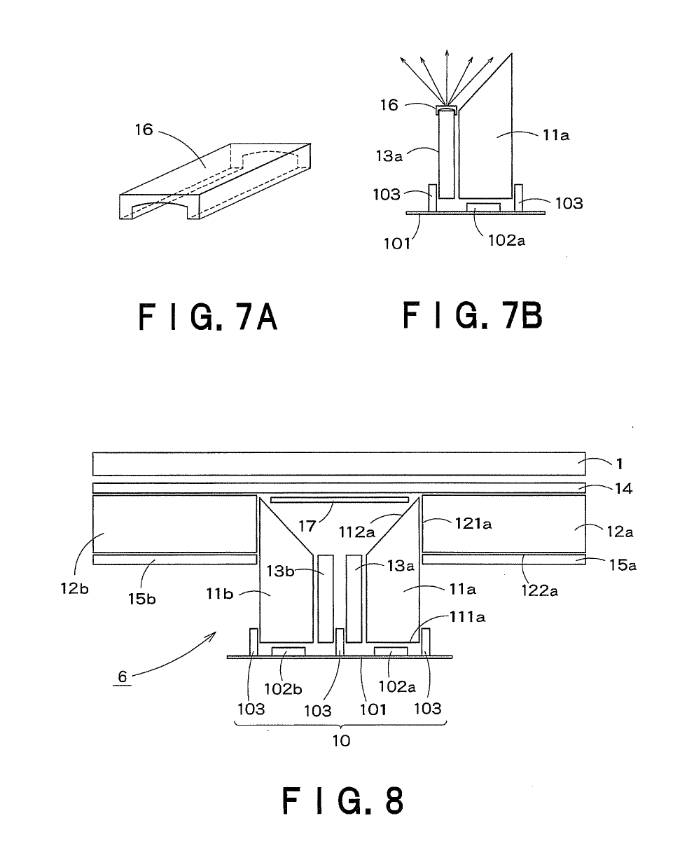

As shown in the perspective view in FIG. 7A and in the cross-sectional view in FIG. 7B, a diffuser member such as a lens cap 16 may be provided on the upper end face of the sub light guide path 13a, to control the luminance distribution of the light exiting from the sub light guide path 13a. Alternatively, as shown in FIG. 8, a diffuser member such as a diffuser plate 17 may be provided between the liquid crystal panel 1 and the upper end faces of the sub light guide paths 13a and 13b.

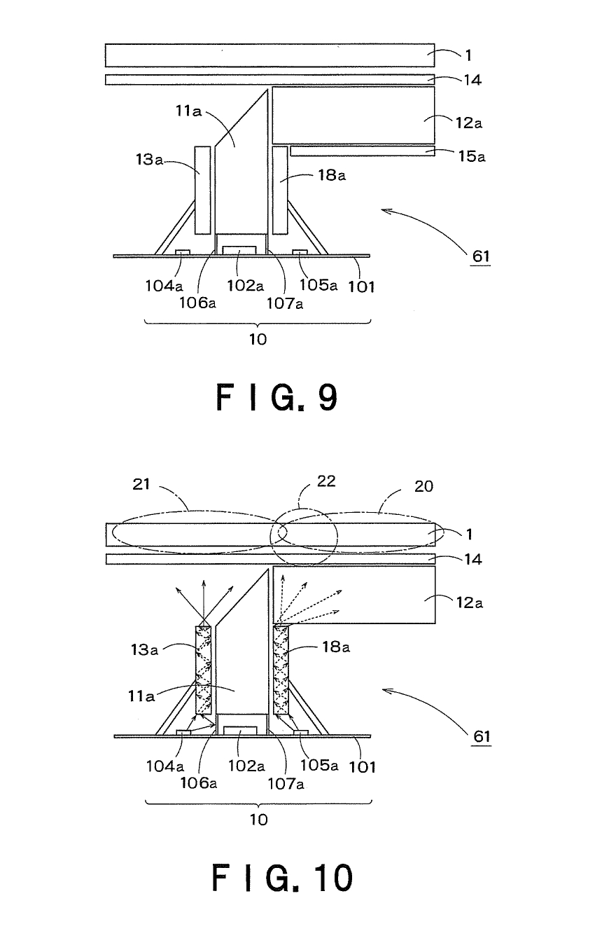

FIG. 9 is a cross-sectional view of the liquid crystal panel 1 and a backlight device 61 as a modification of the backlight device of FIG. 4. The light source module 10′ of the backlight device 61 includes an LED light source 104a and an LED light source 105a, as well as the LED light source 102a for the main light guide path 11a. The LED light source (a second light source) 104a is provided for the sub light guide path 13a. A sub light guide path 18a is further provided to face the side face of the main light guide path 11a on the opposite side from the sub light guide path 13a. The amount of light emitted from the LED light sources 104a and 105a is smaller than that from the LED light source 102a.

A light shielding plate 106a may be provided between the LED light source 102a and the LED light source 104a, so that the light emitted from the LED light source 102a does not enter the sub light guide path 13a, and that the light emitted from the LED light source 104a does not enter the main light guide path 11a. Likewise, a light shielding plate 107a may be provided between the LED light source 102a and the LED light source 105a.

FIG. 10 is a diagram showing the ray paths in the backlight device 61 of FIG. 9. As in FIG. 6B, light exiting from the sub light guide path 13a illuminates the area 21. As the LED light source 104a dedicated for the sub light guide path 13a is provided in the backlight device 61 of FIG. 9, the amount of light from the LED light source 104a can be controlled independent from the amount of light from the LED light source 102a. As a result, the illuminance in the area 21 located above the main light guide path 11a and the sub light guide path 13a can be finely adjusted, and illuminance unevenness on the liquid crystal panel 1 can be further reduced.

Light that is emitted from the LED light source 105a and enters the sub light guide path 18a is extracted from the face facing the side of the liquid crystal panel 1, and illuminates an area (a third area) 22, which is located above the junction area between the exit face of the main light guide path 11a and the incident face of the light guide plate 12a, and surrounds the junction area. In the area 22, light that enters the light guide plate 12a is not sufficiently diffused, and might sometimes become dark. In this case, illuminance unevenness on the liquid crystal panel 1 can be restrained by providing the LED light source 105a and the sub light guide path 18a.

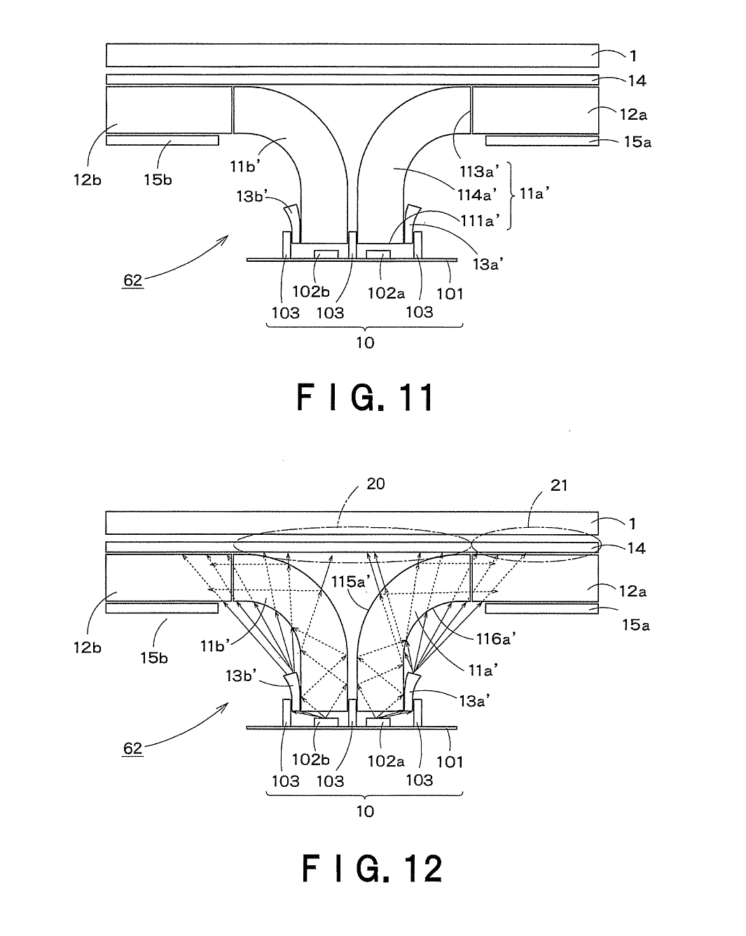

FIG. 11 is a cross-sectional view of the liquid crystal panel 1 and a backlight device 62 as another modification of the backlight device of FIG. 4. The backlight device 62 shown in FIG. 11 includes a light tube 11a′ having a curved shape as a main light guide path. The light tube 11a′ includes an incident face 111a′, an exit face 113a′, and a light guide path 114a′. The incident face 111a′ faces the LED light source 102a, and light is incident on the incident face 111a′ The exit face 113a′ faces the light guide plate 12a and, light exits from the exit face The light guide path 114a′ has a curved shape and guides light from the incident face 111a′ to the exit face 113a′. When the backlight device 62 includes a sub light guide path, the sub light guide path is a light tube 13a′ that also has a curved shape. To reduce the number of components, the light tube 11a′ and the light guide plate 12a may be integrally formed by bending a rectangular acrylic plate while heating the acrylic plate. In the backlight device 62, a LED light source for the light tube 11a′ and a LED light source for the light tube 13a′ may also be provided independently for each other.

FIG. 12 is a diagram showing the ray paths in the backlight device 62 of FIG. 11. Most of light that is emitted from the LED light source 102a to the light tube 11a′ is guided by the light tube 11′, and enters the light guide plate 12a. However, part of the light is leaked from and passes through the outer curved surface 115a′ of the light guide path 114a′, and illuminates the area 20 on the liquid crystal panel 1 located above the light tube 11a′. The amount of light to be leaked to the liquid crystal panel 1 can be controlled by adjusting the radius of the light tube 11a′, for example. In this manner, illuminance unevenness on the liquid crystal panel 1 can be restrained. In the backlight device 62, the LED light source 102a and the curved surface 115a′ of the light tube 11a′ serve as the module for illuminating the area 20.

Further, the light tube 13a′ may be provided as a sub light guide path. Light that is emitted from the LED light source 102a and enters the light tube 13a′ passes through the inner curved surface 116a′ and the outer curved surface 115a′ of the light guide path 114a′, and illuminates the area 20 and the area 21. In this manner, illuminance unevenness on the liquid crystal panel 1 can be restrained.

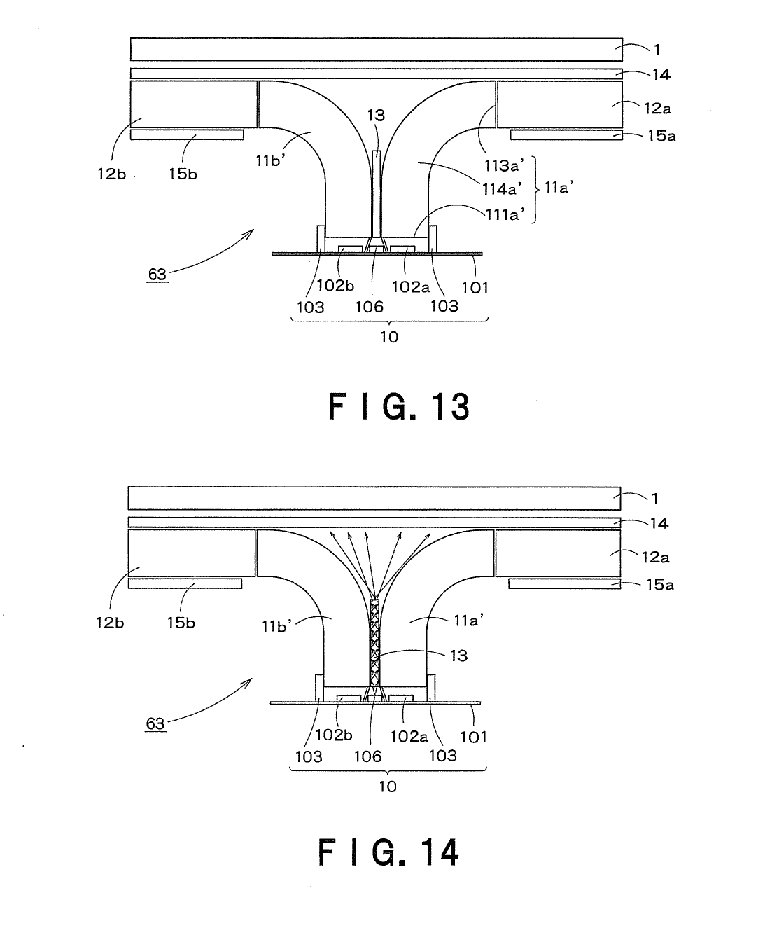

FIG. 13 is a cross-sectional view of the liquid crystal panel 1 and a backlight device 63 as a modification of the backlight device of FIG. 11. FIG. 14 is a diagram showing the ray paths in the backlight device 63. In the backlight device 63 shown in FIG. 13, a sub light guide path 13 is positioned between light tubes 11a′ and 11b′. Light that exits from the sub light guide path 13 and is diffused may illuminate the area 21 on the liquid crystal panel 1. As shown in FIG. 13, a LED light source 106 for the sub light guide path 13 may be provided, and part of light emitted from the LED light sources 102a and 102b may enter the sub light guide path 13.

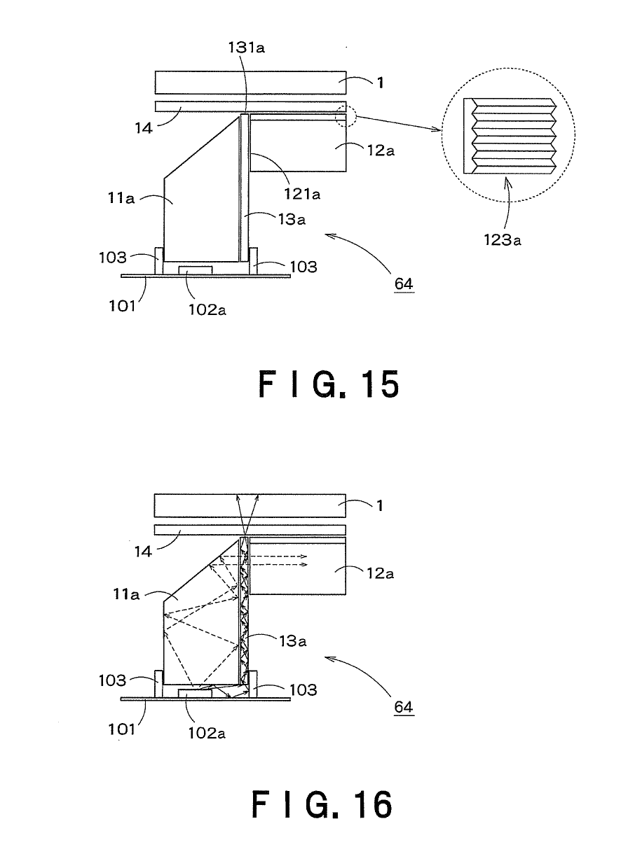

FIG. 15 is a cross-sectional view of the liquid crystal panel 1 and a backlight device 64 as a modification of the backlight device of FIG. 4. FIG. 16 is a diagram showing the ray paths in the backlight device 64. In the backlight device 64 shown in FIG. 15, the sub light guide path 13a is positioned between the main light guide path 11a and the light guide plate 12a. The upper end of the sub light guide path 13a is preferably located close to the optical sheet 14 (or to the liquid crystal panel 1 if the optical sheet 14 is not provided), and the exit face 131a of the sub light guide path 13 is preferably located in a higher position than the upper face of the light guide plate 12a facing the liquid crystal panel 1. This is because, in a case where slit grooves 123a having prism-like shapes are formed in the upper face of the light guide plate 12a to increase the straightness of light, light may be scattered at the slit grooves 123a if light that exits from the exit face 131a at the upper end of the sub light guide path 13a enters the light guide plate 12a from the lower face thereof or from the face 121a facing the main light guide path 11a. Light that exits from the main light guide path 11a and enters the light guide plate 12a travels across the sub light guide path 13a, but this light and light traveling along the sub light guide path 13a do not interfere with each other.

As described above, in this embodiment, light sources are provided below the liquid crystal panel 1, and the main light guide paths 11a and 11b that guide light from the light sources in a direction parallel to the liquid crystal panel 1. Accordingly, it is unnecessary to provide light sources on the sides of the liquid crystal panel 1, and the bezel can be made thinner. Also, a module for illuminating areas on the liquid crystal panel 1 that are not illuminated with the light traveling through the main light guide paths 11a and 11b is provided, so that the illuminances on the liquid crystal panel 1 become uniform. Accordingly, appearance of illuminance unevenness on the liquid crystal panel 1 can be restrained.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fail within the scope and spirit of the inventions.

1. A display apparatus comprising:
a display panel;
a first light source, facing the display panel, configured to emit light toward a direction of the display panel;
a first light guide module the light emitted from the first light source enters, the first light guide module being configured to output the light to a predetermined direction;
a second light guide module, facing a first area on the display panel, configured to guide the light outputted from the first light guide module to illuminate the first area; and
a first illuminating module configured to illuminate a second area on the display panel, the second area being different from the first area.

2. The apparatus of claim 1, wherein the second light guide module and the first illuminating module are arranged at a position to have illuminance of a face facing the second light guide module on the display panel even.

3. The apparatus of claim 1 further comprising a third light guide module configured to guide part of the light emitted from the first light source to the second area.

4. The apparatus of claim 3, wherein the amount of the light which enters the third light guide module from the first light source is less than the amount of the light which enters the first light guide module from the first light source.

5. The apparatus of claim 3, wherein
the first light guide module is arranged facing the first light source, and
the third light guide module is arranged obliquely with respect to the first light source.

6. The apparatus of claim 3, wherein
the first light guide module comprises a first light guide path configured to guide light toward the predetermined direction,
the third light guide module comprises a second light guide path configured to guide light toward the second area, and
the second light guide path is thinner than the first light guide path.

7. The apparatus of claim 3, wherein the amount of the light which enters the third light guide module from the first light source is adjusted so as not to cause unevenness of illuminance on the display panel.

8. The apparatus of claim 7, wherein a reflection member is formed on a surface of the third light guide module so as not to cause unevenness of illuminance on the display panel.

9. The apparatus of claim 5, wherein a distance between the first light source and the third light guide module is set so as not to cause unevenness of illuminance on the display panel.

10. The apparatus of claim 3, wherein the first illuminating module comprises a diffusion member configured to diffuse the light guided from the third light guide module to the second area.

11. The apparatus of claim 3, wherein the first light guide module and the third light guide module are arranged facing the second area.

12. The apparatus of claim 1, wherein the first area is closer to a rim of the display panel than the second area is.

13. The apparatus of claim 1, wherein the predetermined direction is a direction along the display panel.

14. The apparatus of claim 13, wherein the first light guide module comprises a reflection member configured to reflect at least part of the light emitted from the first light source toward a direction along the display panel.

15. The apparatus of claim 1, wherein the first light source is arranged on a frame, and
a reflection member is applied on a surface of the frame.

16. The apparatus of claim 1, wherein the first illuminating module comprises:
a second light source; and
a third light guide module configured to guide light emitted from the second light source toward the second area.

17. The apparatus of claim 16, wherein the amount of the light emitted from the second light source is less than the amount of the light emitted from the first light source.

18. The apparatus of claim 1 further comprising a second illuminating module configured to illuminate a third area, on the display panel, comprising an area neighboring an exit face of the first light guide module and an incident face of the second light guide module.

19. The apparatus of claim 18, wherein
the second illuminating module comprises a light guide path configured to guide light toward the third area,
a prism shape along a traveling direction of light is formed on a face, facing the display panel, of the second light guide module, and
the light guide path is arranged at a position where the light emitted from the light guide path does not enter the second light guide module.

20. The apparatus of claim 1, wherein the first light guide module comprises:
an incident face facing the first light source, the light from the first light source entering the enter face,
an exit face facing the second light guide module, light exiting from the incident face; and
a wave guide path, with curved shape, configured to guide light from the incident face to the exit face.

21. The apparatus of claim 1, wherein the first light guide module and the second light guide module are formed integrally.

22. The apparatus of claim 1 further comprising a tuner configured to receive and tune a broadcast wave,
wherein the display panel is configured to display the tuned broadcast wave.

23. A backlight device comprising:
a first light source configured to emit light toward a first direction;
a first light guide module the light emitted from the first light source enters, the first light guide module being configured to output the light toward a second direction;
a second light guide module configured to guide the light outputted from the first light guide module to illuminate a first area; and
a first illuminating module configured to illuminate a second area different from the first area.
